(19) United States
(12) Patent Application Publication
(10) Pub. No.: US 2005/0089814 A1
(43) Pub. Date: Apr. 28, 2005

(54) Dental matrix for a class II, III or IV restoration

(76) Inventor: Charles E. Slone, San Juan Capistrano, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/802,187

(22) Filed: Mar. 18, 2004

Related U.S. Application Data
(63) Continuation-in-part of application No. 29/192,522, filed on Oct. 24, 2003.

(51) Int. Cl. A61C 5/04

(52) U.S. Cl. 433/39

(57) ABSTRACT

A dental matrix is used to support a filler material placed into a tooth in a class II, III or IV restoration. The matrix has a retainer portion of a thin metal sheet stock having a generally concave surface of a size and configuration capable of abutting the tooth. The retainer portion includes a topper marginal ridge area, a central contact area and a lower, convex shaped gingival margin area, the marginal ridge area and the contact area are made thinner than the gingival margin area. The sheet stock is made of a material that may deform during the insertion process, and that will then resume its original shape when in place.

### RELATED APPLICATIONS

This application is a Continuation In Part Application of a prior filed design application having serial number 29/192,522 and filing date of Oct. 24, 2003 and entitled: Dual Handle Dental Matrix Strip.

### INCORPORATION BY REFERENCE

Applicant(s) hereby incorporate herein by reference, any and all U.S. patents and U.S. patent applications cited or referred to in this application.

### BACKGROUND OF THE INVENTION

1. Field of the Invention

This invention relates generally to apparatus for bounding dental preparations for fillings, and more particularly to a dental matrix of thin metal or plastic, able to slide between abutting teeth so as to be positioned for bounding a class II, III or IV restoration with minimum separation between the teeth and which is able to resume its preformed relatively complex shape when in position.

2. Description of Related Art

The following art defines the present state of this field:

Stark et al., U.S. Des. 253,191 describes a dental matrix design.

Tofflemire, U.S. Pat. No. 3,145,472 describes a pre-contoured dental matrix band comprising: a strip of pliable material having an arcuate central portion and arms extending from the arcuate central portion, with the arms diverging relative to one another when the strip is flat; the strip having an inner surface; the strip having a pair of preformed elongated concavities in its inner surface which are spaced apart; each of the preformed concavities being substantially oval in face view, with the major axis of the oval extending generally lengthwise of the strip.

Tofflemire, U.S. Pat. No. 3,305,928 describes a dental matrix band comprising: a strip of pliable material having an arcuate central portion and a pair of arms extending from the ends of the arcuate central portion, each arm defining a terminal tip at its outer end; the strip having inner and outer faces; a pair of traction instrument-engaging abutments provided on the terminal tips of the arms to extend at substantially right angles relative to the lengths of their respective arms; the abutments projecting laterally beyond at least one face of the strip, and being reinforced so that they will not be sheared off when traction force is exerted thereon; the terminal tip and abutment on one arm being independent and unsecured to the terminal tip and abutment of the other arm, whereby the arms may be selectively moved into parallel contacting relation with one another or the arms freely separated relative to each other; the abutments being defined by independent tubular ends on the tips of the strip that surround and embrace separate rods, the tubes being fixed to their respective rods.

Eames, U.S. Pat. No. 3,842,505 describes a dental matrix band construction of the type including a central tooth-surrounding portion with arms formed at the opposite end of the tooth-surrounding portion. These arms are utilized for securing the band in position on a tooth. The central portion of the band defines a concave interior tooth-engaging surface because of a bend in the upper part thereof, the concavity extending between the top and bottom edges of the central portion. The bottom edge of the band defines a straight edge while the top edge of the band is curved between the respective junctures of the arms and central portion whereby the band is progressively wider from the junctures to the mid-point of the central portion.

Franklin et al., U.S. Pat. No. 3,854,210 describes a matrix the end portions of which are provided with a common surface upon which are mounted a plurality in the longitudinal ribs. A retainer for use in the engagement of the ribs of the above matrix after the latter is placed in the desired position around the peripheral area of a tooth.

Lazarus, U.S. Pat. No. 4,781,583 describes a dental matrix band for engaging around a tooth comprising a plastic sheet member which includes a straight winding portion which can be wound into a coil and a curved tooth engaging portion which is wrapped around to form a tooth engaging band. A lock loop having inner and outer legs is engaged onto overlapping portions of the band to hold the band in position. The locking loop has interior notches which form a gingival inwardly directed bend and tooth contacting point and an elongated gingival open area to provide band's diametric adjustability prior to seating matrix on a tooth, as well as a crimp structure for crimping the occlusal edge of the band to form an occlusal concavity. The coil may be conical and polygonal in shape to more accurately receive a winding burr of a winding tool. The coil is rotatable to tighten the band around a tooth. A retaining end of the sheet material which is on the inside of the band is provided with an elongated laminate to reinforce the plastic band underlying the rotatable coil which is adjacent said retaining end. The coil is wound against this supporting, reinforced area which prevents underlying band from collapsing and being “wrapped-under” by coil which pulls the matrix material through the lock loop with winding of the coil.

Von Weissenfluh, U.S. Pat. No. 4,824,365 describes a matrix consisting of a thin flexible strip of plastic comprising a loop to be placed around the tooth to give the desired shape to the filling material. It is permanently connected to an annular tightener made of material permanently deformable by pressure with the fingers and dentist's forceps, for example, of annealed aluminum sheet. It exhibits, in the front, a slit through which pass the two terminal extensions of flexible strip and, in the back, tabs between which are permanently fastened the ends of said terminal extensions of said strip, so that by compressing said annular tightener it determines the slipping of slit like a slider on the extensions of the strip, the narrowing of loop and the perfect adherence of the loop of the strip to the tooth.

Summer, U.S. Pat. No. 5,505,618 describes a tooth spacer comprising an elongated body having two opposite side edges extending between gingival and occlusal edges. A recessed or thin central portion of the body extends from the gingival edge toward the occlusal edge. The recessed central portion is sufficiently thin so that it may be inserted between the interproximal surfaces of two adjacent teeth while minimizing any wedging of the teeth apart.

McKenna et al., U.S. Pat. No. 6,220,858 describes an apparatus for placement of light curable dental fillings. The apparatus includes a matrix formed of light transparent material and shaped to conform to the natural contour of a tooth in the interproximal zone. The matrix is thinned in its central regions to permit a filling to be made which has close contact with an adjacent tooth. A light transparent wedge has also been invented which selectively conducts light to the base of the tooth preparation and which can be used to conduct light interproximally which light has been applied at either end of the wedge. A clamp has been invented for use with the wedge and/or matrix or for use independently of these devices. The clamp is formed to fit over the top portion of the wedge to enhance engagement against the tooth over previous clamps, which are prevented from extending over the tooth by engagement against the top of the wedge.

Our prior art search with abstracts described above teaches: dental matrix bands, a matrix with retainer, an adjustable plastic film matrix, a dental matrix in a flexible strip with tightener connected to it, a tooth spacer, and an apparatus for placement of dental fillings, but does not teach the use of memory metal technology to provide a complex matrix shape that can be forced grossly out of shape during insertion while resuming its original shape when in a desired position between teeth. The present invention fulfills these needs and provides further related advantages as described in the following summary.

### SUMMARY OF THE INVENTION

The present invention teaches certain benefits in construction and use which give rise to the objectives described below.

The present invention is a dental matrix used to support a filler material placed into a tooth in a class II, III or IV restoration. The matrix is fabricated from a thin sheet stock and has a generally concave surface of a size and configuration capable of abutting the tooth. The retainer portion includes a topper marginal ridge area, a central contact area and a lower, convex shaped gingival margin area, the marginal ridge area and the contact area are made thinner than the gingival margin area. The sheet stock is made of a material that may deform when being inserted, and yet will .then resume its original shape after placement. Such a material may be a nickel-titanium memory alloy, a spring tempered steel alloy or certain memory plastic formulations. In the present invention the memory function of the matrix is critical to its finction in that the matrix can now be made in a thinner, less rigid, form that may be forced between teeth and although being deformed by such insertion, will resume its original smooth surface and surface conformation after being placed. This provides the advantage of a smooth outer surface to the filler material, which is most difficult to achieve after the filler material has hardened because access is obstructed by the adjacent tooth.

A primary objective of the present invention is to provide an apparatus and method of use of such apparatus that yields advantages not taught by the prior art.

Another objective is to provide such an invention capable of being deformed and thereafter resuming its original shape.

A further objective is to provide such an invention capable of being positioned with relative ease.

A still further objective is to provide such an invention capable of being moved bilaterally to position a contact area adjacent to a prepared tooth aperture in a class II, III or IV restoration.

A yet further objective is to provide such an invention capable of such close congruence to the outer surface contour of a tooth as to enable a smaller side aperture preparation as compared to the prior art.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1A is a plan view of a prior art matrix for use in a class II, III or IV restoration; showing how the band is placed from a lateral approach;

FIG. 1B is similar to FIG. 1A showing the prior art matrix in place;

FIG. 2 is a front elevational view of the present invention showing a convex surface;

FIG. 3 is a plan view thereof showing the matrix in place between adjacent teeth;

FIG. 4 is a perspective view thereof showing a preferred method of inserting the matrix between adjacent teeth; and

FIG. 5 is similar to FIG. 4 showing a preferred method of positioning the band laterally.

### DETAILED DESCRIPTION OF THE INVENTION

The above described drawing figures illustrate the invention in at least one of its preferred embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

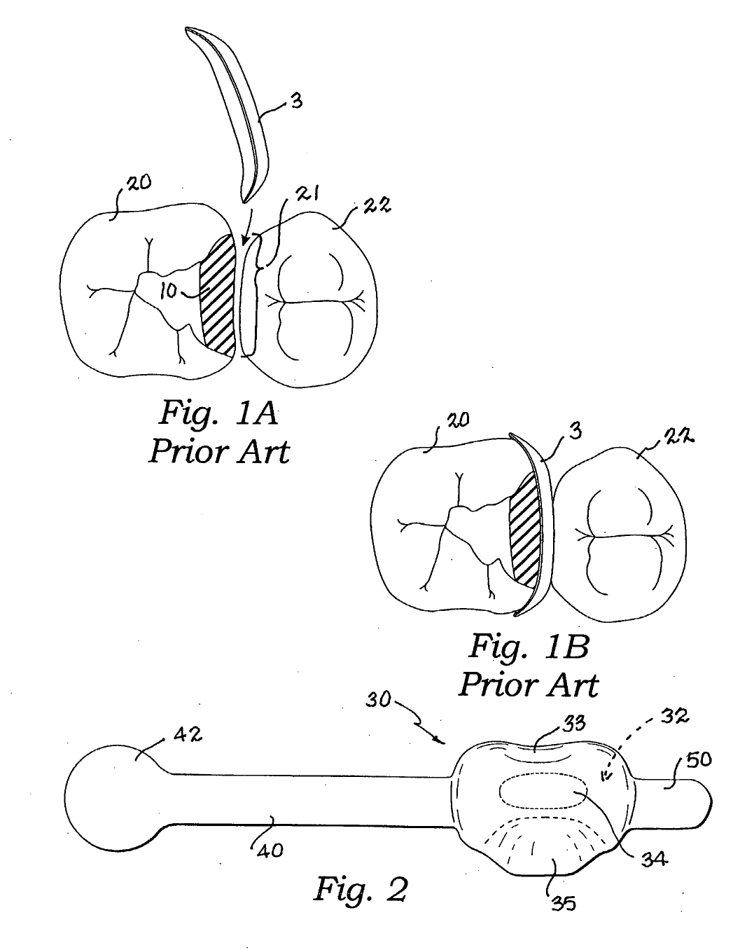

As shown in FIGS. 1A and 1B the most common prior art matrix 3 used for a class II, III or IV restoration is of convex metal or plastic requiring vertical insertion and a wide aperture 21, i.e., excessive removal of tooth structure at the lingual and buccal embrasures and the gingival margin in order to allow the matrix to be inserted without distortion. This, of course, results in excessive patient inconvenience and excessive drilling and preparation time on the part of medical personnel. Unfortunately, the prior art matrix tends to fold or otherwise deform causing the outer surface of the filling to be rough or otherwise undesirable in that it requires excessive finishing steps.

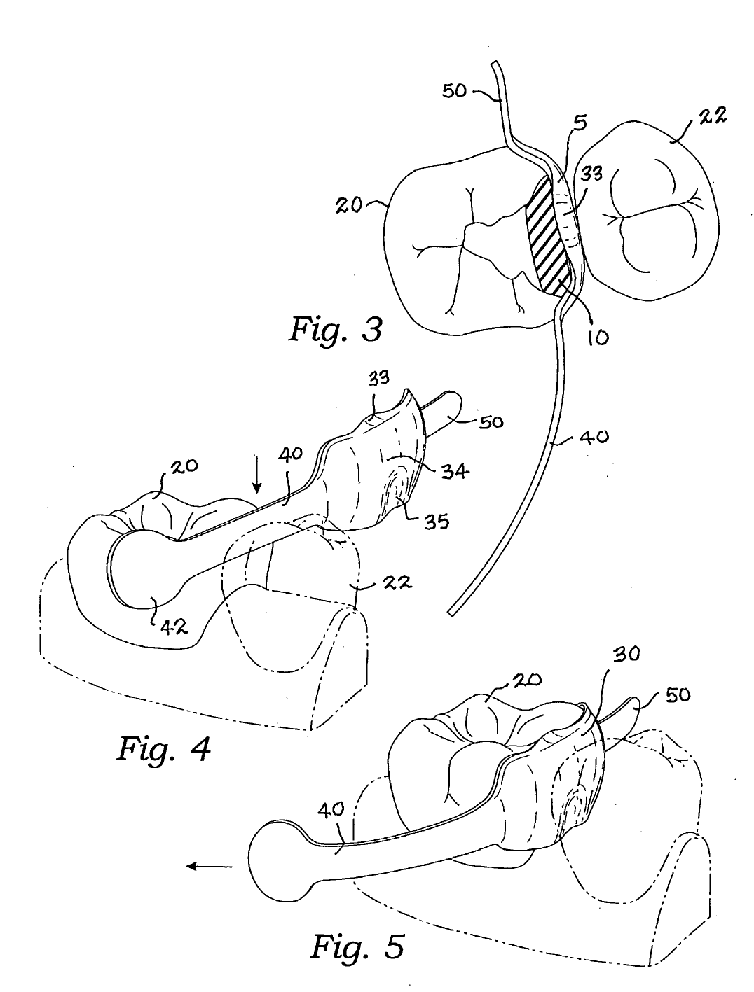

In contrast to the conventional matrix, the present invention, FIGS. 2-5, is a dental matrix apparatus 5 for supporting a filler material 10 when placed for a class II, III or IV restoration in a first tooth 20 that is in close proximity to, or abutting a second tooth 22 as shown in FIG. 3. Referring now to FIG. 2, the apparatus 5 comprises a retainer portion 30 fabricated from a thin metal sheet stock having a generally concave surface 32 (on the back side of retainer portion 30 in FIG. 2) of a size and configuration for abutting the outer surface of tooth 20 as shown in FIG. 2. The retainer portion 30 provides a topper marginal ridge area 33, a central contact area 34 and a lower, convex shaped gingival margin area 35. The marginal ridge area 33 and the contact area 34 are significantly thinner than the rest of the apparatus including the gingival margin area 35. This complex shape and contrast in material thicknesses provides significant advantages, as will be described, so as to achieve the objectives of this invention, and is thus considered to be a critical novel structure.

An elongate insertion tab 40, preferably with a terminal enlarged portion 42 to provide improved gripping, is formed integrally with the retainer portion 30 and extends laterally to one side of it. The insertion tab 40 is of a length that allows for finger gripping by the technician. A repositioning tab 50, preferably shorter than the insertion tab 40, and also integral with the retainer portion 30, extends laterally in opposition to the insertion tab 40 as shown in FIG. 3. Should the retainer portion 30 be pulled too far initially so that the retainer portion 30 is not properly positioned relative to tooth 20, the repositioning tab 50 may be gripped, preferably by a tool, to pull the retainer portion 30 back to a preferred position which is shown in FIGS. 3 and 5. The two opposing tabs 40, 50 of differing lengths is considered to be a critical element in the present invention in enabling lateral insertion of the retainer portion 30 and in enabling repositioning without excessive tab lengths which tend to encumber straightforward dental procedures.

It use the insertion tab 40 is forced between teeth 20 and 22, as shown in FIG. 4 by a downward motion (see arrow) of the apparatus 5, which forces the teeth 20, 22 apart by a small amount; assuming the teeth are abutting. The matrix apparatus 5 is then drawn in the direction of the arrow shown in FIG. 5, until the retainer portion 30 is seated properly, i.e., the contact area 34 is placed where the two teeth 20, 22 are in contact or in closest proximity. In this manner, the matrix is properly positioned, and because of the material of which it is made, it tends to produce a smooth surface on the filling.

To accomplish the above, the thin sheet stock is preferably of a superelastic memory metal alloy of titanium and nickel which can be heat treated to “remember” its heat-treated shape, i.e., smooth surface, regardless of how many times it is straightened out or bent. Such superelastic memory metal alloys, typically nickel-titanium alloys such as Nitinol® or NiTi® alloys, are sold by companies such as Memry Corporation of Bethel, Conn. and Shape Memory Applications, Inc, of San Jose, Calif. Preferably, the present matrix is made of a superelastic memory metal alloy of nickel and titanium in the proportion of about 55.8 Ni to 44.2 Ti, by weight. The present invention may alternately be made of stainless steel with a spring temper so that after being deformed it will resume its original shape when not restrained from doing so. Alternatively, the material used may be pure titanium. Also, certain plastics, such as BioSpan® (segmented polyurethane), Bionate® (polycarbonate urethane), and Elasthane™ (polyetherurethane), manufactured by The Polymer Technology Group, Berkely, Calif. may be used to fabricate a working dental matrix. These plastics can be heat treated to have the property of resuming an initially curved shape, after having been straightened a number of times. Such materials may be reinforced with nylon or stainless steel to produce a relatively high rigidity.

The enablements described in detail above are considered novel over the prior art of record and are considered critical to the operation of the instant invention and to the achievement of the above described objectives. The words used in this specification to describe the invention and its various embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of this described invention and its various embodiments are, therefore, defined in this specification to include not only the combination of elements which are literally set forth, but all equivalent structure, material or acts for performing substantially the same finction in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A dental matrix apparatus for supporting a filler placed into a tooth in a class II, III or IV restoration, the apparatus comprising: a retainer portion of a thin sheet stock and having a generally concave surface for abutting the tooth, the retainer portion providing a topper marginal ridge area, a central contact area and a lower, convex shaped gingival margin area, the marginal ridge area and the contact area of, at most, one-half the thickness of the gingival margin area.

2. The apparatus of claim 1 further comprising an elongate insertion tab integral with the retainer portion and extending laterally therefrom.

3. The apparatus of claim 2 further comprising a repositioning tab integral with the retainer portion and extending laterally therefrom in opposition to the insertion tab.

4. The apparatus of claim 3 wherein the repositioning tab is shorter than the insertion tab.

5. The apparatus of claim 1 wherein the thin sheet stock is of a nickel-titanium alloy having shape memory characteristics.

6. The apparatus of claim 5 wherein the sheet stock comprises about 55.8 percent Ni and about 44.2 percent Ti, by weight.

7. The apparatus of claim 5 wherein the sheet stock is one of Nitinol® and NiTi® alloys.

8. The apparatus of claim 1 wherein the thin sheet stock is of one of a steel alloy, a titanium alloy and pure titanium.

9. The apparatus of claim 8 wherein the alloy is of a spring temper.

10. The apparatus of claim 1 wherein the sheet stock is at least one of segmented polyurethane, polycarbonate urethane, and polyetherurethane.

11. The apparatus of claim 10 wherein the sheet stock is reinforced with one of nylon and stainless steel to improve rigidity.

12. A dental matrix apparatus for supporting a filler material placed into a tooth in a class II, III or IV restoration, the apparatus comprising: a retainer portion of a nickel-titanium memory metal alloy sheet stock having a first thickness, and having a generally concave surface for abutting the tooth, the retainer portion providing a topper marginal ridge overarching the tooth, the marginal ridge area and a contact area formed with a second thickness less than the first thickness.

13. The apparatus of claim 12 further comprising opposing elongate insertion tabs extending laterally from the retainer portion.

14. The apparatus of claim 12 wherein the sheet stock comprises about 55.8 percent Ni and about 44.2 percent Ti, by weight.

15. The apparatus of claim 12 wherein the sheet stock is one of Nitinol® and NiTi® alloys.

16. The apparatus of claim 12 wherein the thin sheet stock is of one of a steel alloy, a titanium alloy and pure titanium.

17. The apparatus of claim 16 wherein the alloy is of a spring temper.

18. The apparatus of claim 12 wherein the sheet stock is at least one of segmented polyurethane, polycarbonate urethane, and polyetherurethane.

19. The apparatus of claim 18 wherein the sheet stock is reinforced with one of nylon and stainless steel to improve rigidity.

20. A method of forming and placing a dental matrix apparatus for supporting a filler material placed into a tooth in a class II, III or IV restoration, the method comprising the steps of: forming a matrix retainer portion of a nickel-titanium memory metal alloy sheet stock having a first thickness, with a generally concave surface for abutting the tooth; forming the retainer portion with a topper marginal ridge area positioned for overarching the tooth and a contact area positioned for tooth contact, the marginal ridge area and a contact area formed with a second thickness less than the first thickness; inserting an insertion tab portion of the matrix apparatus between the tooth and an adjacent tooth in a motion directed toward the gum; and moving the retainer portion into place adjacent the preparation by a lateral force exerted on the insertion tab.
